(19) United States
(12) Patent Application Publication
(10) Pub. No.: US 2008/0305660 A1
(43) Pub. Date: Dec. 11, 2008

(54) DISPLAY AND CIRCUIT DEVICE THEREOF

(75) Inventors: Ya Cao, Hsinchu (TW); Qi-Fei Zhao, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/845,832

(22) Filed: Aug. 28, 2007

(30) Foreign Application Priority Data
Jun. 11, 2007 (TW) 96120945

(51) Int. Cl. H01R 12/00

(52) U.S. Cl. 439/78

(57) ABSTRACT

A display and a circuit device thereof are disclosed. The display includes a circuit device and a panel electrically connected to the circuit device. The circuit device includes a printed circuit board and an electronic device. The printed circuit board includes a first conducting pad set. The first conducting pad set includes a plurality of pads electrically connected to each other. The electronic component includes a first connecting terminal electrically connected to at least one of the pads.

### BACKGROUND OF THE INVENTION

1. Field of the Invention

The invention relates to a circuit device, and more particularly to a circuit device applied to a display.

2. Description of the Related Art

FIGS. 1 and 2 show a conventional circuit device 10 comprising a printed circuit board 11 and a first electronic component 15 (for example an inductance). The circuit board 11 comprises two pads 12 and 13 with conducting areas 121 and 131, respectively. FIG. 1 shows that the first electronic component 15 comprises a first connecting terminal 141 and a second connecting terminal 142 with a large conducting area. The first connecting terminal 151 and second connecting terminal 152 are electrically connected to the conducting areas 121 and 131 respectively. Because diverse materials are applied, a second electronic component 14 with the same function as the first electronic component 15 is provided to replace the first electronic component 15. The shape of the second electronic component 14 is different from that of the first electronic component 15, for example, the first connecting terminal 141 and a second connecting terminal 142 of the second electronic component 14 are smaller than the first connecting terminal 151 and the second connecting terminal 152 of the first electronic component 15. Meanwhile, the first connecting terminal 141 of the second electronic component 14 is electrically connected to the conducting area 121, for example, by soldering. The conventional circuit device 10 has two conducting areas, conducting area 121 and conducting area 131. Much solder is required for the conducting area 121 and conducting area 131, and the solder is easy to overflow into the second electronic component 14, resulting in short circuiting and a waste of cost.

### BRIEF SUMMARY OF INVENTION

A detailed description is given in the following embodiments with reference to the accompanying drawings. The invention provides a circuit device including a printed circuit board and an electronic device. The printed circuit board includes a first conducting pad set. The first conducting pad set includes a plurality of pads electrically connected to each other. The electronic component includes a first connecting terminal electrically connected to at least one of the pads.

The invention provides a display including the above circuit device and a panel electrically connected to the circuit device.

### BRIEF DESCRIPTION OF DRAWINGS

The invention can be more fully understood by reading the subsequent detailed description and examples with references made to the accompanying drawings, wherein:

FIG. 1 is a schematic view of a first electronic component of a conventional circuit device;

FIG. 2 is a schematic view of a second electronic component of a conventional circuit device;

FIG. 3 is a schematic view of an embodiment of the circuit device according to the present invention;

FIG. 4 is a schematic view of another embodiment of the circuit device according to the present invention;

FIG. 5 is a schematic view of another embodiment of the circuit device according to the present invention;

FIG. 6 is a schematic view of another embodiment of the circuit device according to the present invention; and

FIG. 7 is a schematic view of the circuit device for use in a display, according to the invention.

### DETAILED DESCRIPTION OF INVENTION

The following description is based on a preferred embodiment of the present invention. This description is made for the purpose of illustrating the general principles of the invention and should not be taken in a limiting sense. The scope of the invention is best determined by reference to the appended claims.

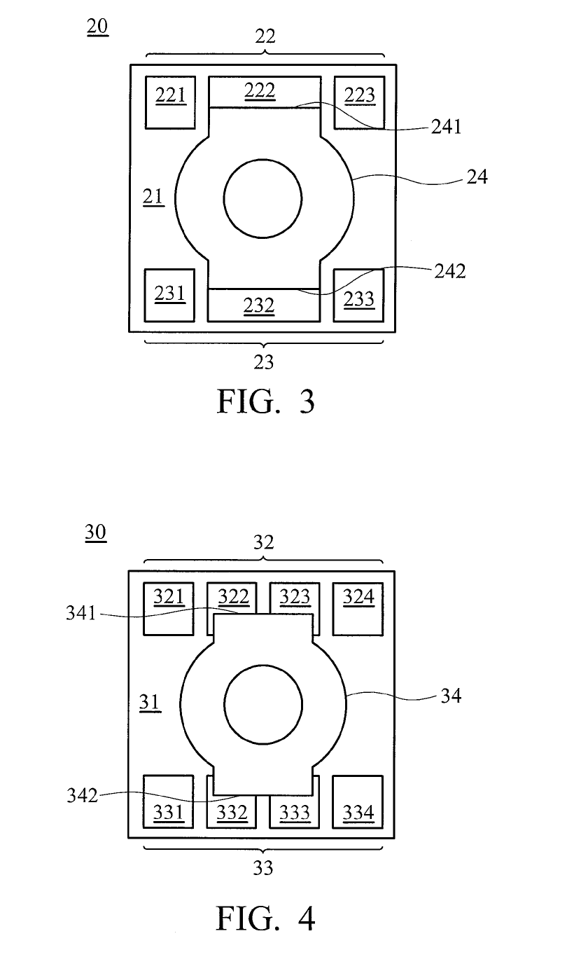

FIG. 3 shows a circuit device 20 comprising a printed circuit board 21 and an electronic component 22. The printed circuit board 21 comprises a first conducting pad set 22 and a second conducting pad set 23. The first conducting pad set 22 comprises a plurality of pads 221, 222 and 223 electrically connected to each other. The second conducting pad set 23 comprises a plurality of pads 231, 232 and 233 electrically connected to each other. The electronic component 24 is disposed on the printed circuit board 21 and comprises a first connecting terminal 241 and a second connecting terminal 242. The first connecting terminal 241 is electrically connected to one of the pads 221, 222 and 223. For example, the first connecting terminal 241 may be connected to the pad 222 by soldering. In this embodiment, the pads 221, 222 and 223 of the first conducting pad set 22 are adjacent and arranged linearly. The first connecting terminal 241 is electrically connected to the pad 222. The pads 231, 232 and 233 of the second conducting pad set 23 are adjacent and arranged linearly. The second connecting terminal 242 is electrically connected to the pad 232.

Note that at least one of pads 221, 222 and 223 of the first conducting pad set 22 on the printed circuit board 21 is left open. In addition, at least one of pads 231, 232 and 233 of the first conducting pad set 23 on the printed circuit board 21 is also left open. In the embodiment, the electronic component 24 is an inductance. However, the electronic component 24 may be other types of electronic components.

According to the previous design, if the type of the electronic component 24 (not shown) is required to be changed during production process, the printed circuit board 21 does not require to be redesigned.

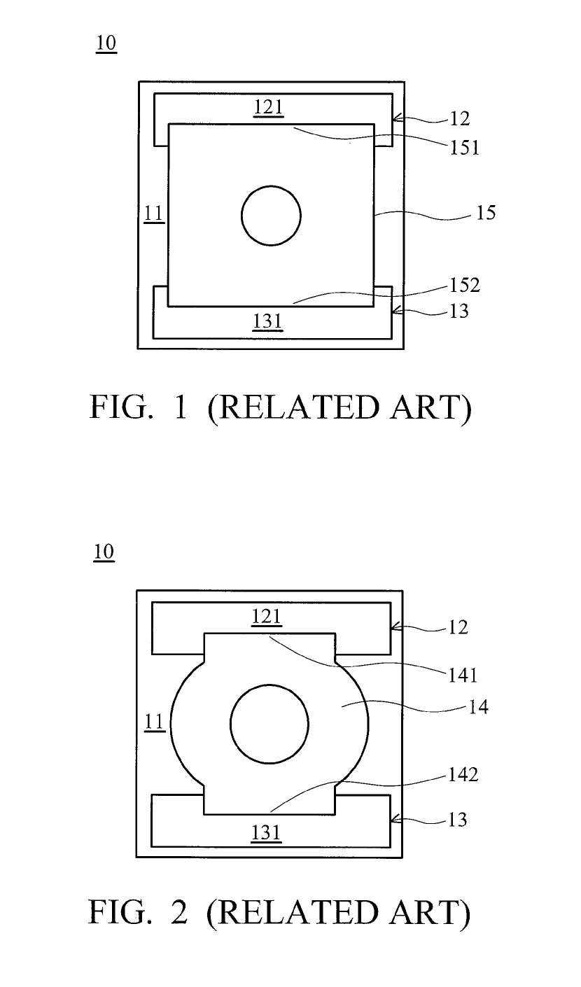

Referring to FIGS. 1 to 3, the conventional pads 12 and 13 only have conducting areas 121 and 131 to electrically connect, for example, by soldering, to the first electronic component 15 and the second electronic component 14. Moreover, the first connecting terminal 141 and the second connecting terminal 142 of the second electronic component 14 are smaller than the first connecting terminal 151 and the second connecting terminal 152 of the first electronic component 15. Thus, when the second electronic component 14 is connected to the printed circuit board 11, too much solder on the conducting area 121 and conducting area 131 will overflow into the second electronic component 14, resulting in a short circuit. In the embodiment, the pads are divided into the first conducting pad set 22 comprising three pads 221, 222 and 223 and second conducting pad set 23 comprising three pads 231, 232 and 233. The design prevents excess solder from flowing into the second electronic component region 14 as it efficiently decreases the quantity of solder on each of the pads 221, 222, 223, 231, 232 and 233, respectively, thus, preventing a short circuit. The circuit device 20, according to the present invention, can also provide the first electronic component 15 with a firm electrical connection to the printed circuit board 21 and can prevent excess solder from flowing into the component 14 when the second electronic component 14 is used.

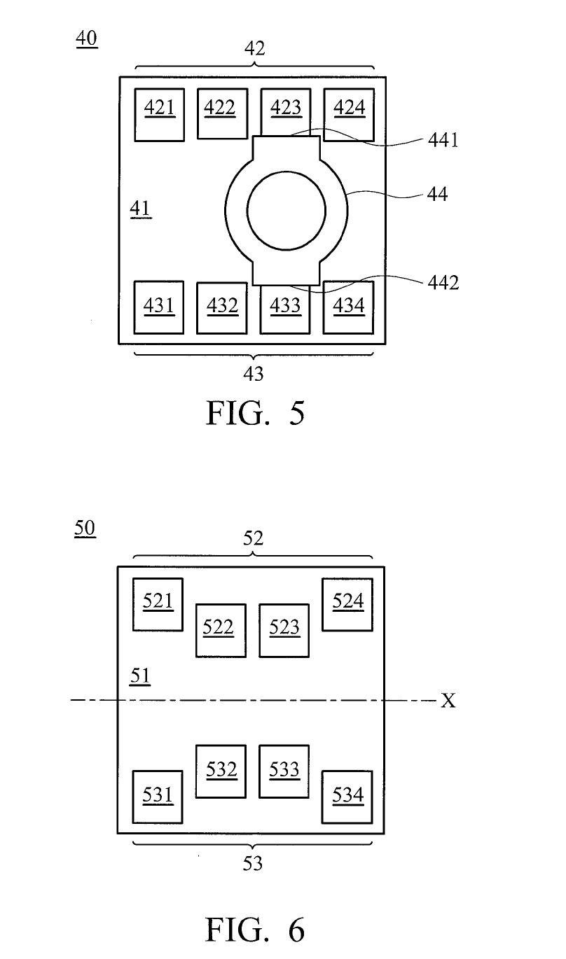

FIG. 4 shows a schematic view of another embodiment of a circuit device of the invention. The first conducting pad set 32 of the circuit device 30 comprises four pads 321, 322, 323 and 324 electrically connected to each other. The second conducting pad set 33 comprises four pads 331, 332, 333 and 334 also electrically connected to each other. The first connecting terminal 341 is electrically connected to the pads 322 and 323 disposed on the middle of the printed circuit board 31. The second connecting terminal 342 of the electronic component 34 is electrically connected to the pads 332 and 333 disposed on the middle of the printed circuit board 31. As shown in FIG. 5, the first conducting pad set 42 comprises four pads 421, 422, 423 and 424 electrically connected to each other. The second conducting pad set 43 comprises four pads 431, 432, 433 and 434 also electrically connected to each other. The first connecting terminal 441 is electrically connected to the pad 433 disposed near the middle of the printed circuit board 41. Namely, the first connecting terminal 441 and the second connecting terminal 442 of the electronic component 44, is electrically connected to the pad 423 and pad 433, respectively (for example by soldering), positioned near the center of the printed circuit board 41.

As shown in FIGS. 4 and 5, if the type of the electronic component (not shown) changes during the process of production, the printed circuit boards 31 and 41 need not to be redesigned. In addition, given the more efficient space disposition of the pads 321 to 324, 331 to 334, 421 to 424 and 431 to 434 of the invention, respectively the shape and the size of electronic components can vary. Furthermore, unlike the large connecting areas of the conventional conducting area 121 and 131 (shown in FIGS. 1 and 2), the more efficiently designed conducting areas 341 and 342 and 441 and 442 (as shown in FIGS. 4 and 5), require less solder, thus preventing short circuit due to excess solder flowing into the second electronic component area.

FIG. 6 shows another embodiment of the circuit device of the invention. While FIG. 6 is similar to FIG. 4, the electronic component is omitted in FIG. 6. In this embodiment, the pads 521 to 524 of the first conducting pad set 52 are not arranged linearly. The pads 531 to 534 of the second conducting pad set 53 are also not arranged linearly. Note that the first conducting pad set 52 and second conducting pad set 53 of this embodiment are axial-symmetric to the x-axis. The design allows flexibility for electronic component application; as such the circuit device of the invention is not limited to the arrangement of the conducting pad sets.

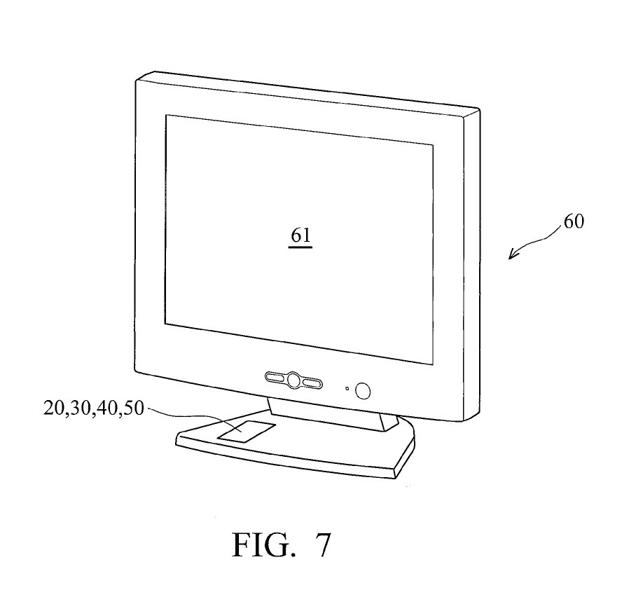

As shown in FIG. 7, the circuit devices 20, 30, 40 and 50 are applied to a display 60, for example a TFT LCD device. The display 60 comprises a panel 61 electrically connected to the circuit devices 20, 30, 40 and 50. The panel 61 is a liquid crystal display panel. If other electronic components are added to the circuit devices 20, 30, 40 and 50 of the display 60, redesigning of the circuit devices 20, 30, 40 and 50 is not required, thus, cost is saved. Moreover, since the more efficient design prevents solder from overflowing into the electronic components, short circuiting is decreased and yield are improved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A circuit device, comprising:
a printed circuit board comprising a first conducting pad set, the first conducting pad set comprising a plurality of pads electrically connected to each other; and
an electronic component comprising a first connecting terminal electrically connected to at least one of the pads;
wherein at least one of the pads of the first conducting pad set is left open.

2. (canceled)

3. The circuit device as claimed in claim 1, wherein the pads of the first conducting pad set are adjoined.

4. The circuit device as claimed in claim 3, wherein the first conducting pad set comprises three pads arranged linearly, and the middle pad is electrically connected to the first connecting terminal.

5. The circuit device as claimed in claim 3, wherein the first conducting pad set comprises four pads arranged linearly, and two middle pads are electrically connected to the first connecting terminal

6. The circuit device as claimed in claim 3, wherein the first conducting pad set are arranged linearly.

7. The circuit device as claimed in claim 1, wherein the printed circuit board further comprises a second conducting pad set with a plurality of pads electrically connected to each other; the electronic component further comprises a second connecting terminal electrically connected to at least one of the pads of the second conducting pad set.

8. The circuit device as claimed in claim 7, wherein at least one of the pads of the second conducting pad set is left open.

9. The circuit device as claimed in claim 7, wherein the first conducting pad set and second conducting pad set are axial-symmetric.

10. The circuit device as claimed in claim 7, wherein the first conducting pad set and second conducting pad set are only electrically connected to the electronic component.

11. The circuit device as claimed in claim 7, wherein the electronic component comprises an inductance.

12. A display, comprising:
a circuit device as claimed in claim 1; and
a panel electrically connected to the circuit device.

13. The display as claimed in claim 12, wherein the panel comprises a liquid crystal display panel.
